(19) United States
(12) Patent Application Publication
(10) Pub. No.: US 2003/0046378 A1
(43) Pub. Date: Mar. 6, 2003

(54) Apparatus and method for existing network configuration

(76) Inventors: Sheri L. Zimmel, Richardson, TX (US); Kristopher E. Glover, Richardson, TX (US); Anna A. Maravina, Richardson, TX (US); Mark W. Lewis, Oxford, MS (US); Ronald S. Stites, Plano, TX (US)

Correspondence Address: Rudolf O. Siegesmund, Suite 2000, 4627 N. Central Expressway, Dallas, TX, 75205, US

(21) Appl. No.: 09/905,766

(22) Filed: Jul. 14, 2001

(51) Int. Cl. G06F 15/173

(52) U.S. Cl. 709/223; 709/228

(57) ABSTRACT

An automatic router for new demands on an existing network topology with given network capacities which first transforms the existing network topology into a Capacity Network, to which mathematical techniques and heuristics techniques can be applied. Subsets of the given unrouted new demands using a min-cost flow technique are solved. Optionally, an overlay network may be built to accommodate any new demands which cannot be placed on the existing network.

### CROSS-REFERENCE TO RELATED APPLICATIONS

This application is related to U.S. patent application Ser. No. 09/710,377, and to Attorney Docket Numbers 010403, 010404, 010405, and 010406 (to be amended to include application numbers after they have been assigned), by Sheri L. Zimmel, et al.

### INCORPORATION BY REFERENCE

The related applications U.S. patent application Ser. No. 09/710,377, and Attorney Docket Numbers 010403, 010404, 010405, and 010406 (to be amended to include application numbers after they have been assigned), by Sheri L. Zimmel, et al., are hereby incorporated by reference in their entireties, including figures and drawings.

### TECHNICAL FIELD OF THE INVENTION

This invention pertains to the arts of network planning, design and optimization, and especially to those arts related to the analysis, design, and optimization of ring-type networks within existing telecommunications and data communications networks.

### FEDERALLY SPONSORED RESEARCH AND DEVELOPMENT STATEMENT

This invention was not developed in conjunction with any Federally sponsored contract.

### MICROFICHE APPENDIX

Not applicable.

### BACKGROUND OF THE INVENTION

In recent years, two major technological and social forces have interacted to accelerate the planning, design, and deployment of communications networks. The public switched telephone network (“PSTN”) has converted from analog technology to digital technology, and Internet and intranet traffic has grown exponentially. The conversion to digital technology and the growth in Internet and intranet traffic have enabled and driven convergence of voice and data traffic in communications networks.

The convergence has caused changes in the types of equipment specified, purchased and operated by communications network operators, such as local or regional telephone services providers or “regional Bell operating companies” (“RBOCs”), long distance carriers, and data communications services companies.

The convergence has also caused communications network operators to offer new services beyond the traditional offerings such as “plain old telephone” service (“POTS”), long distance service, and data communications. New services offered from a single service provider now minimally includes long distance, virtual private networks, Internet traffic management and website hosting, and the traditional services. As a result of these increased service demands, communications network operators are driven to maximize the utilization of existing network topologies, to create new networks, and to expand existing networks.

When new networks are needed to meet new demands, telecommunication companies turn to design engineers to create a cost effective network by developing ring topologies for the demands. Due to increasing network complexities the engineers need software to generate multiple network configuration scenarios to determine customized network configuration solutions to meet particular needs rather than generic network design.

Network configuration optimization problems are not unique to the communications industry. City street traffic planning, railroad cargo and railcar routing, and airline routing share the same fundamental concepts, problems and needs. As such, those skilled in the arts of any of these technologies, or in the more generic technologies of graph and network theory, will recognize that the methods and tools provided to assist engineers practicing one art will be readily useable or adaptable to other related arts. For example, in graph theory terminology, a “vertex” would correspond to a “node” in a telecommunications network, and an “edge” or “path” would correspond to a “span”. Likewise, a “cycle” in graph theory terminology would correspond to a “ring” in a telecommunications network. As such, algorithms commonly employed in graph theory are often useful in telecommunications network planning and design.

Optimization of network resources requires proper use of network topology. Communications networks have several fundamental topologies. The simplest of the topologies is the “point to point” network. FIG. 1 depicts “point to point” network 10 with “node A” 11 connected to “node B” 12 by “span A-B” 15, “node B” 12 connected to “node C” 13 by “span B-C” 16, “node C” 13 connected to “node D” 14 by “span C-D” 17. “Node A” 11, “node B” 12, “node C” 13 and “node D” 14 may consist of telephony switches, such as central-office class switches (e.g. SS7 switches) and data routers. “Span AB” 15, “span BC” 16, and “span CD” 17 may be wired telecommunications transmission media, such as T1, DS3, optical transmission means, or wireless technologies such as microwave or satellite transceivers. Communication “spans” or “links” are formed between two nodes, such as “node A” 11 and “node D” 14. Intermediate nodes, such as “node B” 12 and “node C” 13, may also be traversed as traffic travels between “node A” 11 and “node D” 14.

Characteristically, topologies, which use single links between each node in the path between end points, do not offer alternate paths to a destination at any particular node. These types of topologies may be the least expensive networks to implement, primarily because of the lack of redundant hardware and span cabling or fiber. However, these types of topologies are also generally prone to catastrophic failure because the failure of one node or one span in the network may result in a total loss of communications between the effected sections of the network.

A “star” topology is also a network arrangement, found most often in the arrangement between extension telephones and a private branch exchange switch (“PBX”), or between client computers and a local area network (“LAN”) hub. Star topologies are found less often in a telecommunications transport arrangements. FIG. 2 shows star 20 wherein “node K” 21 is a hub providing centralized switching or routing to outlying “node E” 22, “node F” 23, “node G” 24, “node H” 25 and “node J” 26. A star topology is cost-efficient in terms of the costs of switching or routing hardware and span media. The star topology can survive the loss of one of the outlying nodes. However, failure of “node K” 21 results in total loss of communications in the network, and thus the star network is not suitable for high-reliability applications.

A “ring” topology is a topology in which a path can be found from a starting point or node though the network back to the starting point or node. It is often used in local area networks as well as wide area networks. FIG. 3 depicts ring 40 as an example of a “ring” network. The most fundamental form of a ring network is a unidirectional ring, in which traffic traverses the ring in a clockwise or counterclockwise direction. Failure of any single span or node in the unidirectional ring can isolate a portion of the ring for communications. A more common type of ring is a counter-rotational ring, in which traffic traverses the ring in both directions, clockwise and counter-clockwise. A counter-rotational ring can be “self-healing” by looping back traffic when a node or span fails. For example, if “node P” 44 fails, the traffic headed towards “node P” 44 from “node N” 43 and “node Q” 45 may be looped back onto the counter direction ring, thus forming a virtual ring of Q-L-M-N-M-L-Q. Thus, only traffic sourced from or destined to “node P” 44 is lost, and all other traffic may continue to flow to and from all other nodes. Therefore, counter-rotational ring topology has become the most prevalent topology in communication networks.

A “mesh” network is a network implemented using a topology in which at least two nodes are connected by more than one path. In a fully connected mesh network, all nodes of the network are connected to each other by a direct path. A “hybrid” network is a combination of any two or more network topologies.

FIG. 4 shows network 60 as an example of a typical real network topology. Network 60 can be viewed in part as several ideal network topologies interconnected to each other (stars, rings and point-to-points). The interconnected network topologies typically include hundreds to thousands of nodes and spans interconnected in irregular patterns. Nodes may be co-located, such as on a corporate campus, or they may be physically disparate, such as in different cities.

The topologies are used for communication. Communication means the transfer of information among users or processes, according to Protocol Hierarchy Systems. Data means the representation of facts, concepts, or instructions in a formalized manner suitable for communication, interpretation, or processing by humans or by automatic means.

A communication system is any organized assembly of communications resources and procedures united and regulated by interaction or interdependence to accomplish a set of specific functions in the transfer of information. Telecommunication is any transmission, emission, or reception of signals, images, sounds or intelligence of any nature by wire, radio, optical, or other electromagnetic systems. A signal is any detectable transmitted energy that can be used to carry information in a communication system. A digital signal is a signal in which discrete steps or values are used to represent information.

A source is that part of a system from which messages are considered to originate. A destination is that part of a system to which messages are considered to be directed. A sink is a device that receives information, control, or other signals from a source. A demand in communications networks is the complete set of communications signals carried by a communications system or a set of communications systems. A transition point is a location within a communications network at which a demand unit moves from one system to another.

A demand unit, in communications networks, is a unit of communication that consumes some level of bandwidth available in a communications network. A separation is the spatial distance between the source and destination of a traffic demand as determined by the number of systems traversed in delivering the demand from the source to the destination. The speed is the rate of communications between two points in a communications network. The term speed may refer either to the communications rate possible between two pieces of network equipment or to the bandwidth consumed by a demand unit placed upon communications system. A communications network element is a piece of communications equipment that allows a demand unit to either enter or exit a communications network, or transition to another system within the communications network.

Protocol Hierarchy Systems are constructions of interrelated levels of signals in a communications system. Protocol Hierarchy Systems include, but are not limited to T-Carrier (T-n), DS-n, E-Carrier, E-n, Optical Carrier (OC-n), SONET, Synchronous Transport Signal (STS-n), Synchronous Transport Module (STM-n), and Ethernet.

Digital Signal (DS) means a signal in which discrete steps or values are used to represent information, and also means a communications protocol used within an electrical-based signal multiplexing system commonly used by telecommunications carrier networks, known as T-carrier.

Digital Signal (DS-n) is the generic designator for any of several digitally multiplexed telecommunications carrier systems. A generalized protocol used in the transmission of digitized electrical signals from a source to a sink in a communications network. This protocol is adapted to handle specific communications rates agreed to by convention. By convention, communications networks utilizing the digital signal protocol may communicate information at one or more of the following rates: DS0, DS1, DS1C, DS2, DS3 and SDS3 (SYNTRAN). Other transfer rates may be extrapolated by a creator of a digital signal transmission system that do not conform to conventional rates but are never the less considered elements of the digital signal hierarchy.

T-carrier is the generic designator for any one of several digitally multiplexed telecommunications carrier systems commonly used in North America and have a base signal rate of 64-kbps. T-carrier systems are composed of both a physical and a logical communications protocol.

E-carrier is the generic designator for any one of severally digitally multiplexed telecommunications carrier systems commonly used outside of North America and have a base signal rate of 64-kpbs. E-carrier systems are composed of both a physical and a logical communications protocol.

Optical Carrier is a physical digital signal transmission system that utilizes photons rather than electrical impulses to transmit digitized information between sources and sinks in a communications network. The preferred transmission media for optical carrier systems is commonly acknowledged to be fiber optic media though “through-the-air” optical carrier transmission systems exist.

Synchronous Optical Network (SONET) is a communications system that has both electrical and optical transmission components. Physical communications are performed by using photons to communicate logically interleaved digitized signals from sources to sinks of a network over a media, commonly found to be fiber optic elements. The physical communications media is referred to as the optical carrier. This optical carrier may communicate at various signaling rates. By convention, SONET initially supported up to 256 levels of optical carrier communications rates though, by convention, only a handful of the levels were implemented, specifically OC-1, OC-3, OC-12, OC-48, OC-192, and OC-768, each level being an integral multiple of the Level 1 Optical Carrier rate (OC-1 communicates at a line rate of 51.940-Mbps). Because communications technology in various fields of research continues to improve, n is no longer seen to be limited at 256 and may be any value indicating an integer multiple of the base rate unit OC-1.

Synchronous Transport Signal (STS) is the electrically oriented logical protocol component of SONET communications systems. For every optical carrier level of a SONET system, a complementary synchronous transport signal exists at that level (the level of one Optical Carrier (OC-1) is complemented by an STS-1 signal, the level three Optical Carrier (OC-3) is complemented by an STS-3 signal, and so on).

Each protocol has a hierarchy. T-carrier systems are created to enable electrically based digital signals of 64-kbps to be multiplexed into signals of increasing communications rate. By convention, several T-carrier systems commonly exist though proprietary systems may be constructed having non-conventional multiplexing systems but operate as T-carrier systems. Table 1 delineates the conventional T-carrier systems available in the art presently.

TABLE 1
T-Carrier System Hierarchy

| | | Digital Signal | Signal | |
|---|---|---|---|---|
| Signal Level | Base Rate | Level | Channels | Bit Rate |
| 0 | 64-kbps | DS-0 | 1 | 64-kbps |
| 1 | 64-kbps | DS-1 | 24 | 1.544-Mbps |
| 1C | 64-kbps | DS-1C | 48 | 3.152 Mbps |
| 2 | 64-kbps | DS-2 | 96 | 6.3123 Mbps |
| 3 | 64-kbps | DS-3 | 672 | 44.736 Mbps |

E-carrier systems are created to enable electrically based digital signals of 64-kbps to be multiplexed into signals of increasing communications rate. By convention, several E-carrier systems commonly exist though proprietary systems may be constructed having non-conventional multiplexing systems but operate as E-Carrier systems. Table 2 delineates the conventional E-carrier systems available.

TABLE 2
E-Carrier System Hierarchy

| | | E-Carrier | Signal | |
|---|---|---|---|---|
| Signal Level | Base Rate | Signal Level | Channels | Bit Rate |
| 0 | 64-kbps | E-0 | 1 | 64-kbps |
| 1 | 64-kbps | E-1 | 30 | 2.048 Mbps |
| 2 | 64-kbps | E-2 | 120 | 8.448 Mbps |
| 3 | 64-kbps | E-3 | 480 | 34.368 Mbps |
| 4 | 64-kbps | E-4 | 1920 | 139.268 Mbps |
| 5 | 64-kbps | E-5 | 7680 | 565.148 Mbps |

An Optical Carrier (OC-n) is a physical digital signal transmission system that utilizes photons rather than electrical impulses to transmit digitized information between sources and sinks in a communications network. The preferred transmission media for optical carrier systems is commonly acknowledged to be fiber optic media though “through-the-air” optical carrier transmission systems exist.

A signal level hierarchy exists for the transmission of information using optical carrier. Table 3 illustrates the most common signal levels available using optical carrier technology and the transfer rates available.

TABLE 3
Conventional Optical Carrier Signal Transfer Levels

| Signal Level | Optical Carrier | Data Rate |
|---|---|---|
| 1 | OC-1 | 51.840-Mbps |
| 3 | OC-3 | 155.520-Mbps |
| 12 | OC-12 | 622.080-Mbps |
| 48 | OC-48 | 2,488.320-Mbps |
| 192 | OC-192 | 9,953.280-Mbps |
| 768 | OC-768 | 39,813.12-Mbps |

Synchronous Digital Hierarchy (SDH) is a communications system that has both electrical and optical transmission components. Physical communications are performed by using photons to communicate logically interleaved digitized signals from sources to sinks of a network over a media, commonly found to be fiber optic elements. The physical communications media is referred to as the optical carrier. This optical carrier may communicate at various signaling rates. By convention, SDH utilizes minimally, levels 3, 12, 48, and 192 of the Optical Carrier hierarchy OC-3, OC-12, OC-48, and OC-192) to signal Synchronous Transport Module signals of level 1, 4, 16, and 64 (STM-1, STM-4, STM-16, and STM-64). Table 4 illustrates common Synchronous Transport Signal levels and their associated data transfer rates.

TABLE 4
Conventional Synchronous Transport Signal Transfer Levels

| Signal Level | Optical Carrier | Data Rate |
|---|---|---|
| 1 | STM-1 | 155.520-Mbps |
| 4 | STM-4 | 622.080-Mbps |
| 16 | STS-16 | 2,488.320-Mbps |
| 64 | STS-64 | 9,953.280-Mbps |

Bit Rate is the rate at which individual bits of digitized information are signaled through a communications network. A DS-0 signal of the Digital Signal Hierarchy is signaled through a communications network at 64-kbps.

Bit Rate Hierarchy is a hierarchy of bit rate levels that may be created to accommodate the transmissions of information through a communications network. The Digital Signal Hierarchy has a bit rate hierarchy of 64-kbps, 1.544-Mbps, 3.152-Mbps, 6.312-Mbps and 44.736-Mbps corresponding to the hierarchy levels of DS-0, DS-1, DS-1c, DS2, and DS-3.

The Ethernet communications protocol has physical and logical components. The physical component corresponds to the rate at which information is signaled between sources and sinks of a communications network. The logical component provides a protocol to decipher the digitized data into meaningful bundles of information. Though technology continues to improve and bit rates will continue to rise, the bit rate hierarchy for Ethernet is illustrated as follows in Table 5.

TABLE 5
Ethernet-related Bit Rates

| Bit Rate | Description |
|---|---|
| 1-Mbps | 1/10^{th} Standard Ethernet |
| 10-Mbps | Standard Ethernet |
| 100-Mbps | Fast Ethernet |
| 1,000-Mbps | Gigabit Ethernet |
| 10,000-Mbps | 10-Gigabit Ethernet |

In the related applications, new methods and systems for identifying potential cycles in an existing network and efficiently routing demands in networks were disclosed. However, each existing network has a finite capacity to carry traffic, and even when the traffic balance has been optimized, this finite capacity to carry traffic cannot be exceeded.

Many of the currently available network planning tools offer analysis and optimization of traffic and demand routing based upon existing networks topologies. However, when optimization efforts have yielded a plan which approaches the maximum capacity of the existing network, it is then necessary to augment the existing network in such a way to accommodate any new demands. This is typically done manually, but augmenting the network in a trial manner, and the re-running an analysis and optimization tool to determine if the augmentation meets specified criteria and is acceptable.

As this manual process may involve several iterations before an acceptable plan is developed, there is a need in the art for a system and method which can both optimize a given existing network's utilization plan in order to accommodate new or additional demands, and to be able to synthesize modifications to the existing network when the addition of a demand exceeds the capacity of the existing network.

In one of the related applications, a method and system was disclosed which employed mathematical techniques and heuristics techniques to find cycles within a network topology to satisfy given demand criteria. There is a need in the art, therefore, for a system and method which transforms a network topology into a structure to which mathematical techniques and heuristics techniques can be applied to achieve near optimal routing efficiency.

### SUMMARY OF THE INVENTION

The apparatus and method disclosed provides automatic routing of new demands on an existing network topology with given network capacities by first transforming the network topology into a structure to which Mathematical techniques and heuristics techniques can be applied. The system and method take a set of new demands and places as many of them as possible on an existing network structure, given as inputs the current system(s) and their capacities.

To accomplish this placement, the existing network is translated to a Capacity Network, and subsets of the given un-routed demand using a min-cost flow technique are solved.

### BRIEF DESCRIPTION OF THE DRAWINGS

The figures presented herein when taken in conjunction with the disclosure form a complete description of the invention, wherein elements and steps indicated by like reference indicators are the same or equivalent elements or steps.

FIG. 1 depicts an example of a point-to-point topology network.

FIG. 2 depicts an example of a star topology network.

FIG. 3 depicts an example of a ring topology network.

FIG. 4 gives an example network arrangement which more closely resembles the topologies found in existing communications networks.

FIG. 5 shows a distributed data processing system in which the present invention can be implemented.

FIG. 6 depicts a data processing system in which the present invention may be implemented.

FIG. 7 presents the object model of the preferred embodiment.

FIG. 8 shows the logical process of the invention.

FIG. 9 sets forth the logical flow of the NetDesignController class when Xnetmode equals 1.

FIG. 10 illustrates the logical flow of the NetDesignController class when Xnetmode equals 2.

FIG. 11 shows the logical flow of NetDesignController class when Xnet mode equals 0 or when allowOverlay equals 1.

FIG. 12 provides an object model for the capacity network class.

FIG. 13 sets forth the logical process of the capacity network class.

FIG. 14 depicts the logical flow of the demand partitioner class.

FIG. 15 shows the pre-flow push class logical flow.

FIG. 16 illustrates the logical flow of the cost scaling class.

FIG. 17 shows the logical flow of the Bellman-Ford class.

FIG. 18 discloses the logical flow of the path finding class.

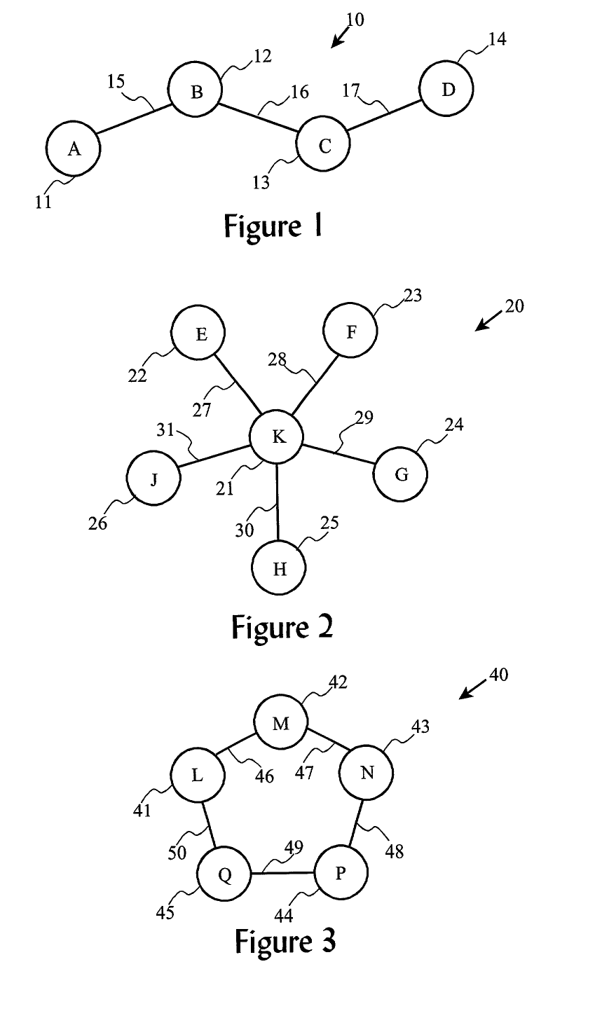

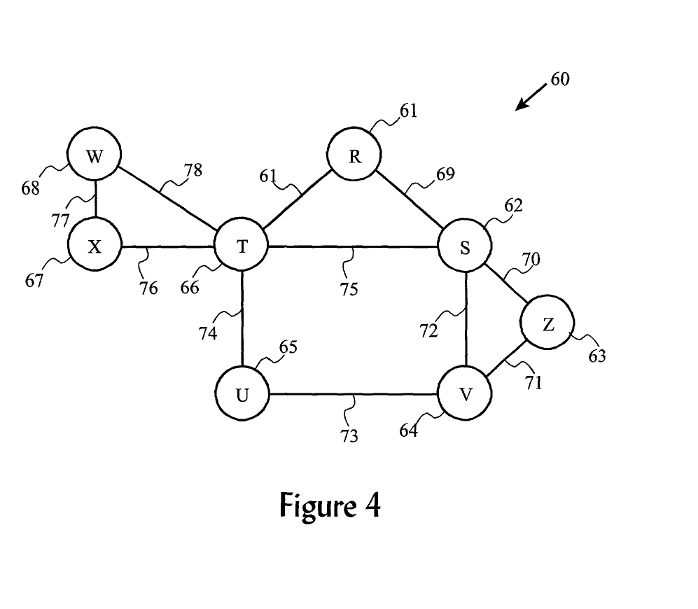

### DETAILED DESCRIPTION OF THE INVENTION

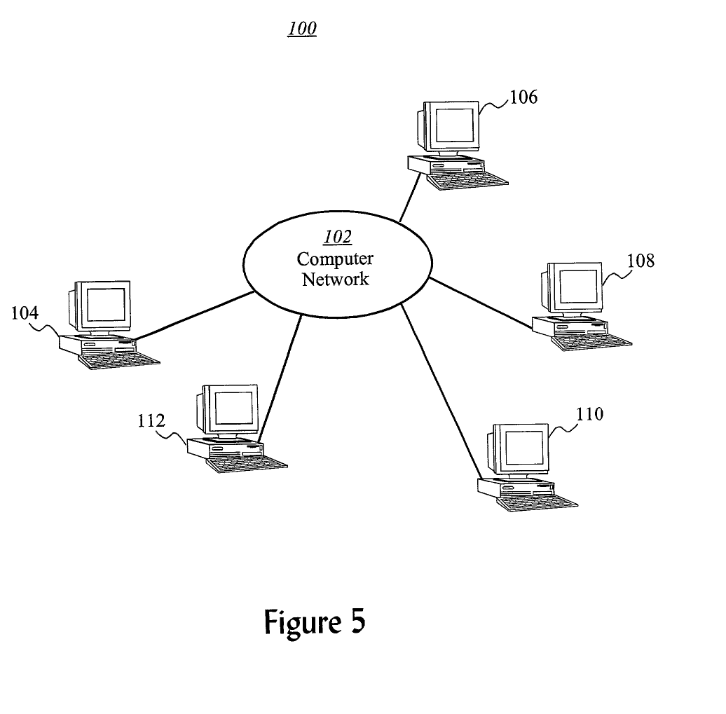

FIG. 5 depicts a pictorial representation of a distributed data processing system in which the present invention may be implemented, and is intended as an example but not as an architectural limitation, for the processes of the present invention. Distributed data processing system 100 is a network of computers which contains a network 102, which is the medium used to provide communications links between various devices and computers connected together within distributed data processing system 100. Network 102 may include permanent connections, such as wire or fiber optic cables, or temporary connections made through telephone connections, personal computers or network computers. Distributed data processing system 100 may include additional servers, clients, and other devices not shown.

In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as for example, an intranet, a local area network (LAN), or a wide area network (WAN).

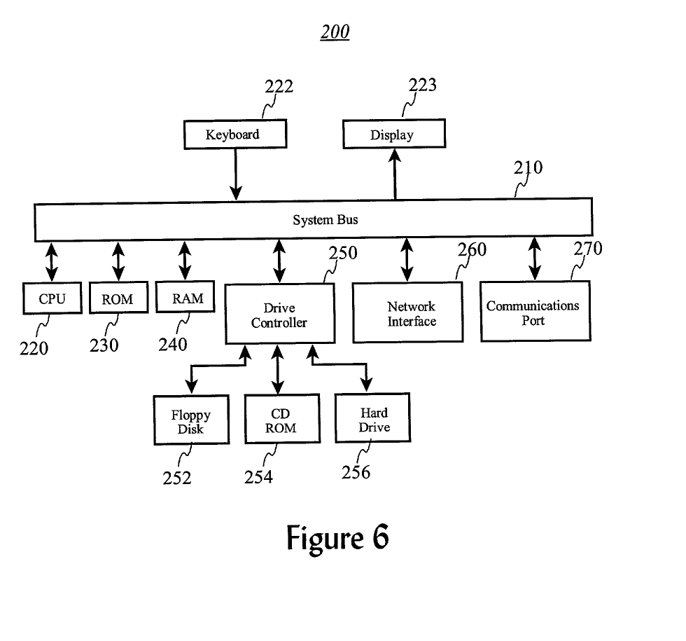

FIG. 6 depicts computer 200. Although the depicted embodiment involves a personal computer, a preferred embodiment of the present invention may be implemented in other types of data processing systems. An exemplary hardware arrangement for computer 200 follows. Keyboard 222 and display 223 are connected to system bus 210. Read only memory (ROM) 230 contains, typically, boot strap routines and a Basic Input/Output System (BIOS) utilized to initialize Central Processing Unit (CPU) 220 at start up. Random Access Memory (RAM) 240 represents the main memory utilized for processing data. Drive controller 250 interfaces one or more disk type drives such as floppy disk drive 252, CD ROM 254 and hard disk drive 256. The number and type of drives utilized with a particular system will vary depending upon user requirements.

A network interface 260 permits communications to be sent and received from a network. Communications port 270 may be utilized for a dial up connection to one or more networks while network interface 260 is a dedicated interface to a particular network. Programs for controlling the apparatus shown in FIG. 6 are typically stored on a disk drive and then loaded into RAM for execution during the start-up of the computer.

In an initial step of the method performed by the invention, the topology or interconnection of an existing network are received by the system as in a common format such as shown in Table 6. Table 6 is an example of a Comma Separated Variable (“CSV”) data in which a first node by followed by a second node are identified as being interconnected by single span. Additionally, the distance between the nodes may be denoted in a third parameter.

### TABLE 6: Example Network Topology CSV File Contents

first node, second node, distance

R,S,69

R,T,61

W,T,78

W,X,77

X,T,76

T,S,75

T,U,74

S,V,72

S,Z,70

Z,V,72

U,V,73

end of file (“EOF”)

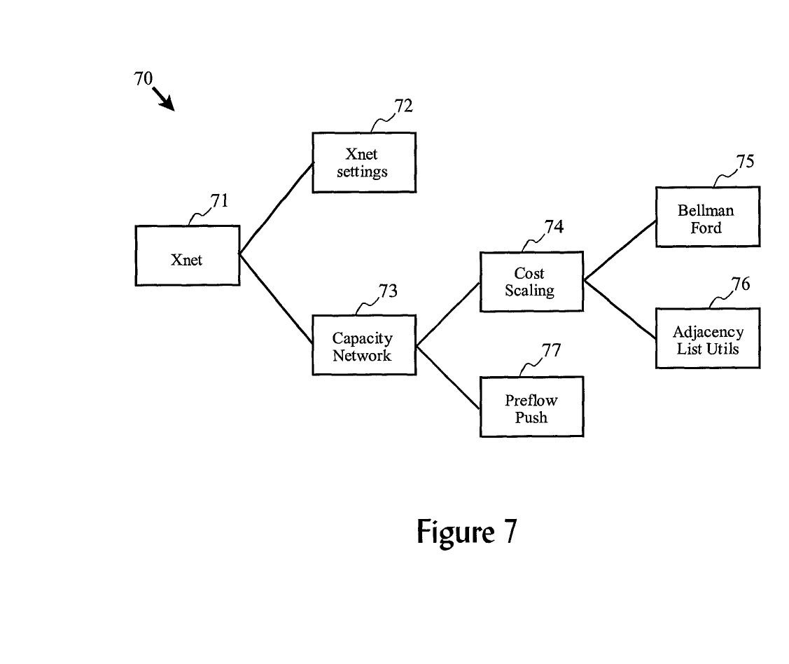

Turning to FIG. 7, the object model of the preferred embodiment is shown. The existing networks program (“Xnet”) 71 accesses several classes of functions to be described in more detail now.

The capacity network class 73 transforms the SONET network organization into a connected topology. This is accomplished by modeling system equipment interactions (transitions) with transition nodes that mark the behavior of equipment within the network. By doing this transformation, the system brings the problem into the realm of Network Flows in Mathematical techniques and heuristics. This allows the system to apply proven optimal techniques on subsets of the problem, and then combine the solutions to the sub problems together to get an extremely good solution to the overall problem.

The cost scaling class 74 contains algorithms, techniques and methods that solve the basic min-cost flow problem. According to the preferred embodiment, the system takes advantage of the shared capacity bi-directional arcs that models the BLSR technologies, by only storing one arc, and differing the information about the shared capacity arc on the fly. This greatly reduces the number of pivots to consider when adjusting the flow in the network. The system also takes advantage of the UPSR technologies by modeling the system as single arcs, which decreases the number of arcs in the modeled network.

The pre-flow push class 71 is a maximum-flow algorithm that allows the system to trim unrouted demand clusters to amounts that can be handled by the cost scaling class.

The Bellman-Ford optimality check class 75 is used towards the end of the cost scaling process after the current flow of demand converges with the optimal min-cost flow, in which a series of degenerative pivots occur before optimality has been reached. Degenerative pivots are costly in computation time, and provide very little enhancements to the solution. The Bellman-Ford optimality check takes advantage of the fact that a min-cost flow solution is said to be optimal when no negative cycles exists in the minimum-spanning tree that represents that flow. The system waits until the pseudo-cost adjustment decrease past a certain threshold, and then every iteration of the cost scale algorithm runs the Bellman-Ford optimality check to quit early, and save the compute time caused by the degenerative pivot.

The adjacency list utilities class 76 are a set of utilities that convert the flow represented in the adjacency list to individual demands and then assigns those routes to the proper unrouted demand. The flow received from the cost scaling algorithm is one contiguous flow with no separation of specific demand.

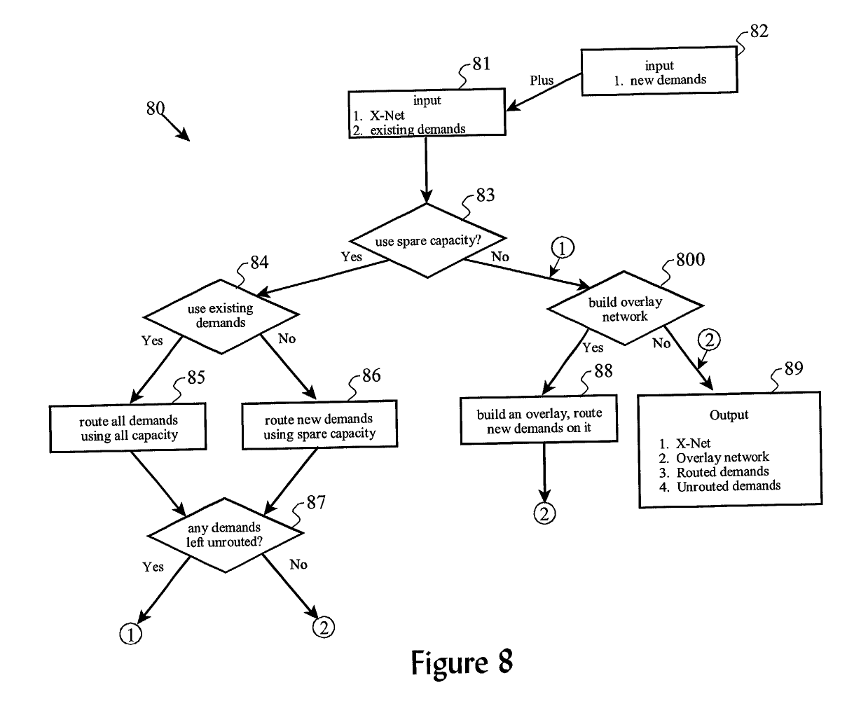

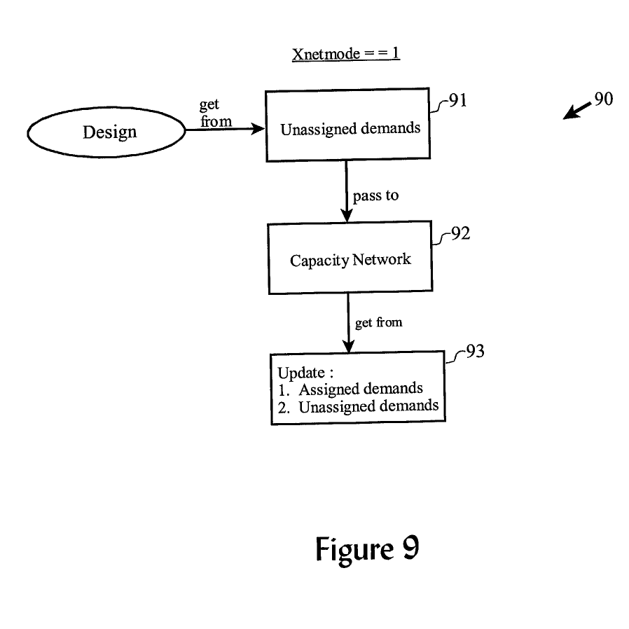

The Xnet settings class 72 allows the user to interact with the system to define the preferences, or enables it as described in FIG. 8. This preferably includes a graphical user interface including three radio buttons and a check box. The check box corresponds to enabling or disabling the building of an overlay network. And the radio buttons allow the selection of one of three options including modifying the existing network, using existing capacity, or using the existing demand and capacity. With this radio button, only one of these three options may be selected.

Turning to FIG. 8, the logical flow 80 of the Xnet process is shown. First, the system receives 81 input of a description of the existing network and the existing demands which are routed on that network. It also receives input 82 of the new demands to be routed on the network. If spare capacity on existing network is to be used 83, and existing demand are to be maintained 84, then all (new and existing) demands are routed or rerouted using all the capacity of the existing network 85. If after that process is complete any demands are left unrouted 87, then an option to build an overlay network is given.

If the user authorizes or has configured 800 the system to build an overlay network, then the overlay network is built 88, and the demands or the remaining demands are routed on it.

Finally, the system outputs 89 the existing network, the overlay network that has been built, a list of the routed demands, and a list of any unrouted demands.

If the system is not to be use to spare capacity 83 for the routing of demands, then it automatically provides the option 800 to build the overlay network. If building of an overlay network is enabled 800, then the overlay network is built and new demands are routed on it 88.

If spare capacity is to be used 83, but the existing demands are not to be maintained as routed on the network 84, then only the new demands are routed using the spare capacities 86. Following this step, if any new demands are left unrouted, then the process follows the previously described process of building an overlay network.

A NetDesignController class 90 provides the Xnet process with the ability to analyze the existing network and do routing according to the user provided settings. As such, the NetDesignController class 90 receives the Xnet settings, and has an integer variable “Xnetmode”, and a Boolean variable “allowOverlay”, that represent the Xnet settings in the program and which define the way that the program flows. The integer variable Xnetmode can take one of three values:

0=for “do not touch the existing network”;

1=for “use existing capacity”; and

2=for “using existing demand and capacity.”

The allowOverlay boolean variable is true if the check box is marked or otherwise selected by the user, which authorizes or configures the system to build an overlay network to accommodate demands which are otherwise unroutable on the existing network.

So, depending on the values of Xnetmode and allowOverlay variables, the system may call the capacity network functions or the “Weighted Span” (WS) algorithms which were described in the related patent applications. For example, if Xnetmode equals 1 or 2, it calls the capacity network functions. However, if Xnetmode equals 0, capacity network functions are not called. If allowOverlay is true, then the WS program is called. The WS program is described in a related application.

Turning to FIG. 9, the logical flow of the NetDesignController class 90 when Xnetmode equals 1 is shown. First, a list of unassigned demands is retrieved 91 from the design criteria. Then, the capacity network class functions 92 are passed the list of unrouted demands, at which time the demands are routed and a list 93 of routed demands and unrouted demands are returned to the NetDesignController class.

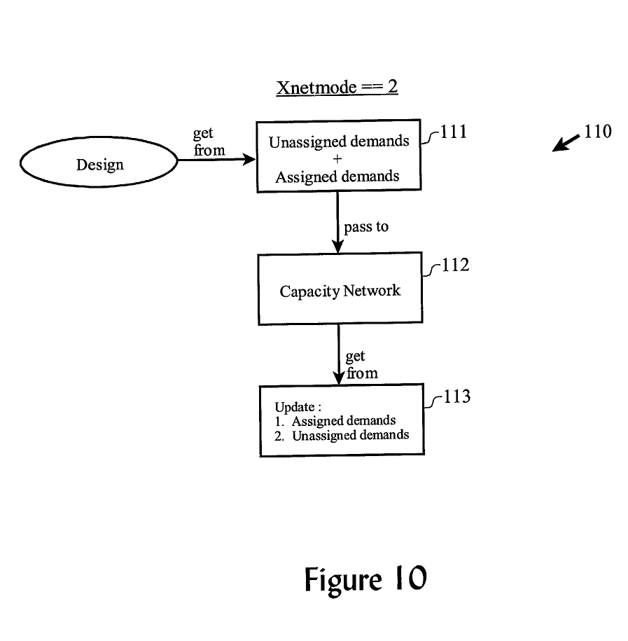

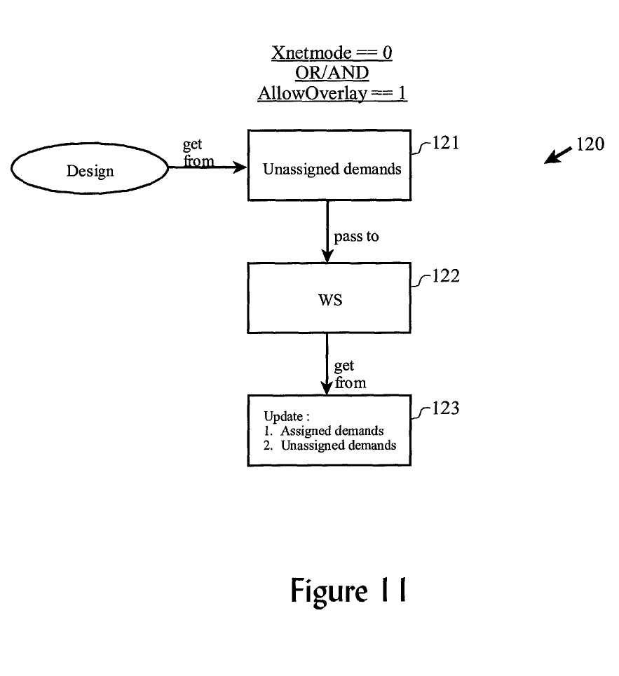

Turning to FIG. 10, the logical flow of the NetDesignController class when Xnetmode equals 2 is shown 110. Again, the list of unassigned demands and a list of assigned demands are accessed 111 from the design criteria. Then, these are passed to the capacity network class 112, which routes the demands, creates a list of routed demands, and creates a list 113 of the unrouted demands. The assigned demands are removed from the existing network before routing.

FIG. 11 shows the logical flow of NetDesignController class when Xnet mode equals 0 (modification of the existing network disabled) or when allowOverlay equals 1 (overlay creation enabled) 120. First, the list of unassigned demands is obtained from the design criteria 121. This list is passed to the WS class 122, which routes the demands, and creates a list 123 of routed demands and unrouted demands. The results of this process are then retrieved by the NetDesignController class, and the assigned demands and unassigned demands are updated. The WS class is described in more detail in the related application.

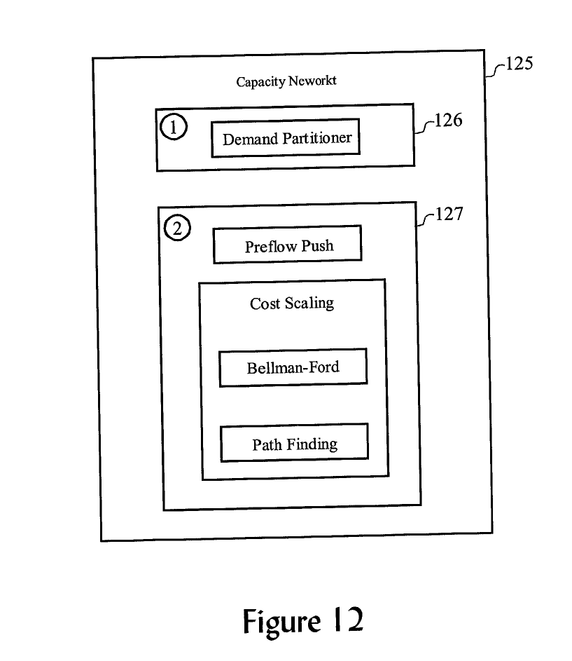

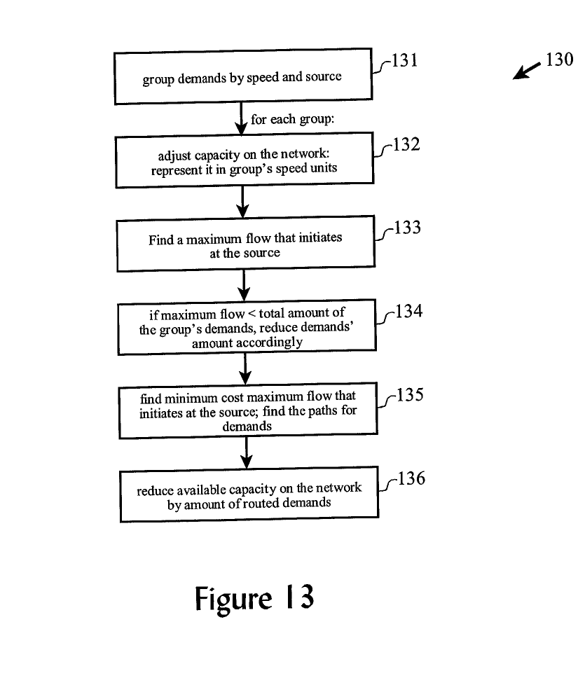

An object model 125 is shown in FIG. 12 for the capacity network class; the logical process 130 of the capacity network class is shown in FIG. 13. It first breaks the list of demands into groups of demands 131, and then routes demands by groups 132-136.

In the first phase of capacity network processing, a demand partitioner class 126 is executed which breaks 131 the list of demands into groups. The demand partitioner creates groups of demands that have the same speed and the same source. Then, they are grouped with the highest speed grouped first and the lowest speed grouped last.

In the second phase of capacity network processing, a pre-flow push class and a cost scaling class 127 are instantiated to route the demand groups. First, the pre-flow push class is used to find the maximum flow in the network from the source of a group of demands. The cost scaling class is then used to find the minimum cost maximum flow in the network from the source of demands. The cost scaling class is assisted by two classes: the Bellman-Ford class and the Path Finding class.

The Bellman-Ford class checks the flow for optimal condition to finish the search earlier. The Path Finding classm also referred to as the Adjacency List Utilities, reads the minimum cost maximum flow into the real paths.

Turning to FIG. 13, the logical flow of the capacity network class is shown in more detail. First, the demands are grouped by speed and source 131 using the demand partitioner class. Then, for each group, the capacity is adjusted 132 on the network by representing in the group's speed unit.

Next, the maximum flow that initiates at the source is found 133. Then, if the maximum flow is less than the total amount of the group demands, the demand's amount are reduced accordingly 134.

Next, a minimum cost maximum flow is found 135 that initiates at the source, and paths for the demands are found. Finally, the available capacity on the network is reduced 136 by the amount of the routed demand.

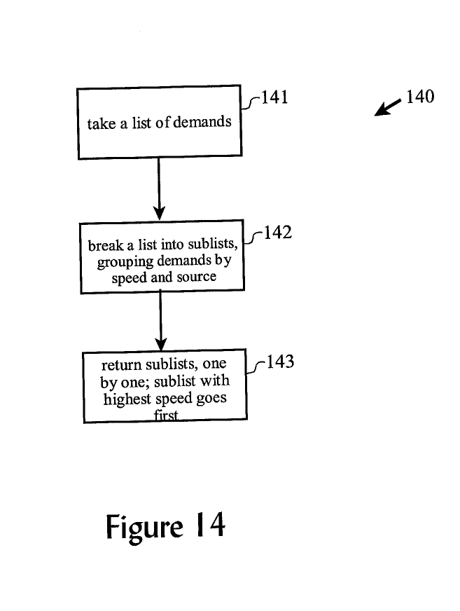

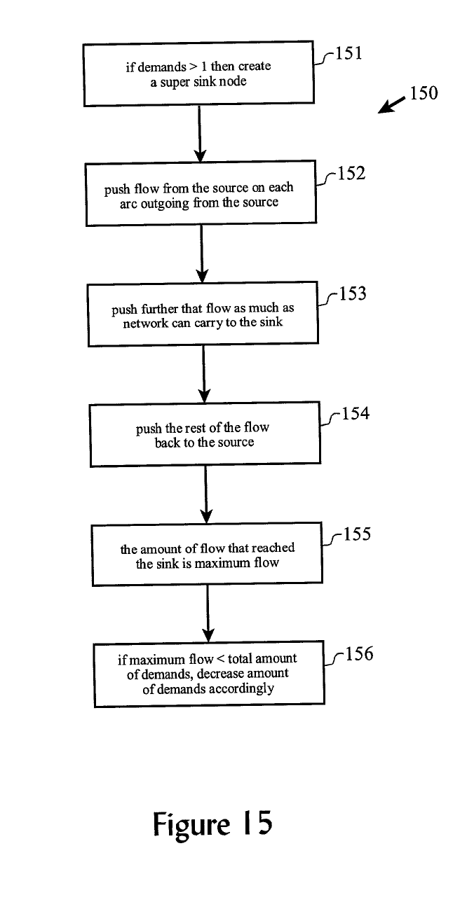

Turning to FIG. 14, the logical flow 140 of the demand partitioner class is shown. First, the list of demands is received 141. Then, the list is broken 142 into sub-lists, and grouped by speed and source. Finally, the demand partitioner class returns 143 the sub-lists, one by one, with the sub-lists at the highest speed being returned first and sub-list with the lowest speed being returned last.

Turning to FIG. 15, the pre-flow push class logical flow 150 is shown. First, if the number of demands is greater than one than a supersink k-node is created 151. Then, the flow is pushed 152 from the source on each arc outgoing from the source.

Next, that flow is pushed 153 further, as much as the network can carry it to the sink. Then, the rest of the flow is pushed 154 back to the source, followed by calculating the maximum flow by determining the amount of flow that has reached the sink 155. Finally, if the maximum flow is less than the total amount of the demand, the amount of demand is decreased accordingly 156.

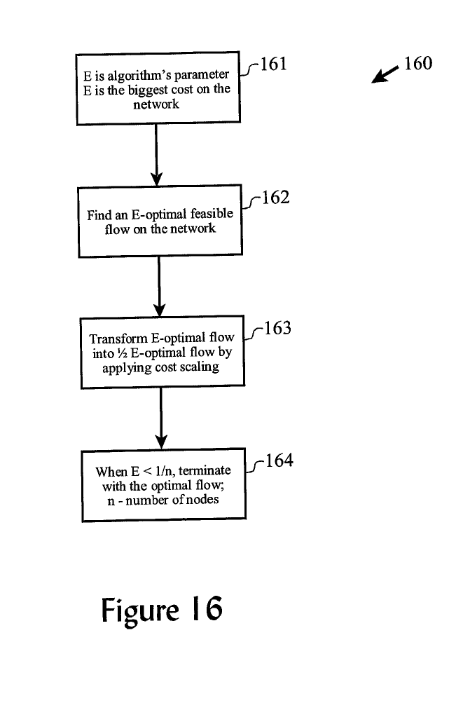

The logical flow 160 of the cost scaling class is shown in FIG. 16. In the first step, a variable “E” is used as the process cost parameter, in which E is the greatest cost on the network 161. Then, a cost optimal and feasible flow on the network is found 162.

Next, the cost optimal flow is transformed into one-half of the cost optimal flow by applying cost scaling 163. Finally, if “E” is less than the reciprocal of the number of nodes in a network, then the cost scaling class terminates with the optimal flow having already been found.

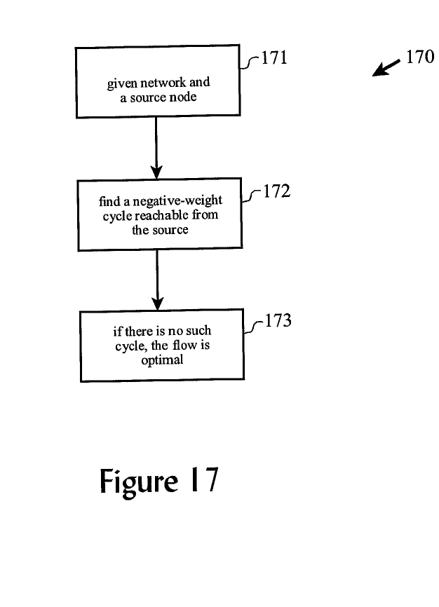

The logical flow 170 of the Bellman-Ford class is shown in FIG. 17. First, the network topology and a source node are taken 171 as input. Next, a negative-weight cycle reachable from the source is found 172. Last, if there is no such cycle, the flow is already optimal 173. The general Bellman-Ford class techniques are well-known in the art.

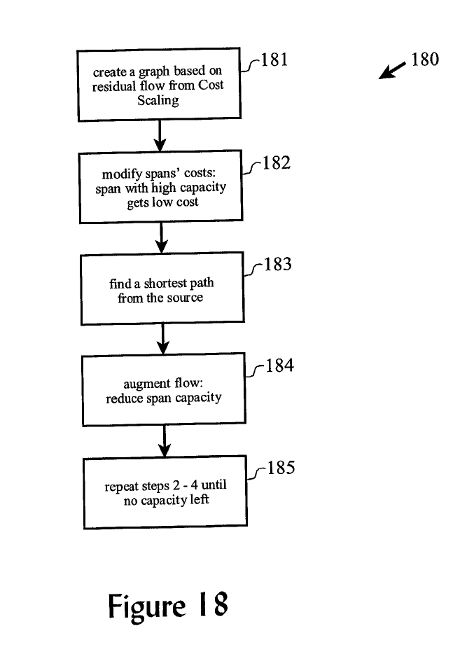

Finally, turning to FIG. 18, the logical flow 180 of the path finding class is disclosed. First, a graph based on the residual flow from cost scaling is created 181. Next, the spans' costs are modified such that the span with the highest capacity gets the lowest cost 182. Then, a shortest path from the source is found 183, following which the flow is augmented 184 to reduce the span capacity. Finally, steps 182 through 184 are repeated 185 until no capacity is left available in the network.

While certain details of the preferred embodiment have been disclosed herein, it will be recognized by those skilled in the art that many variations, substitutions, and alternate embodiments may be employed without departing from the spirit and scope of the invention, including use of alternate programming methodologies, equivalent process step orders, and equivalent data representations.

What is claimed:

1. A method of placing a number of unrouted new demands on an existing network structure comprising the steps of:
translating the existing network to a capacity network such that it is conducive to application of mathematical and heuristics techniques, said capacity network being organized as a connected flat topology;
solving subsets of the unrouted new demands using min-cost flow processes in order to route as many of the new demands onto the existing network as can be accommodated by the existing network; and
outputting a list of routed demands and unrouted demands.

2. The method as set forth in claim 1 wherein said step of translating the existing network to a capacity network comprises modeling system equipment interactions or transitions with transition nodes that mark the behavior of equipment within the existing network, thereby rendering a representation of the existing network in an operations research network flows domain.

3. The method as set forth in claim 1 wherein said step of solving subsets of the unrouted new demands uses only spare capacity of the existing network for routing of new demands, such that routing of all pre-existing routed demands is maintained.

4. The method as set forth in claim 1 wherein said step of solving subsets of the unrouted new demands uses all capacity of the existing network for routing of new demands such that pre-existing routed demands are not accommodated by a final solution.

5. The method as set forth in claim 1 further comprising the steps of:
building an overlay network in response to having unroutable demands on said existing network;
routing said unroutable demands on said overlay network; and
outputting a description of said overlay network.

6. The method as set forth in claim 1 further comprising the step of re-routing any existing demands.

7. A computer readable medium encoded with software for placing a number of unrouted new demands on an existing network structure, said software when executed by a computer causing the computer to perform the steps of:
translating the existing network to a capacity network such that it is conducive to application of mathematical and heuristics techniques, said capacity network being organized as a connected flat topology;
solving subsets of the unrouted new demands using min-cost flow processes in order to route as many of the new demands onto the existing network as can be accommodated by the existing network; and
outputting a list of routed demands and unrouted demands.

8. The computer readable medium as set forth in claim 7 wherein said software for translating the existing network to a capacity network comprises software for modeling system equipment interactions or transitions with transition nodes that mark the behavior of equipment within the existing network, thereby rendering a representation of the existing network in an operations research network flows domain.

9. The computer readable medium as set forth in claim 7 wherein said software for solving subsets of the unrouted new demands is adapted to use only spare capacity of the existing network for routing of new demands, such that routing of all pre-existing routed demands is maintained.

10. The computer readable medium as set forth in claim 7 wherein said software for solving subsets of the unrouted new demands is adapted to use all capacity of the existing network for routing of new demands such that pre-existing routed demands are not accommodated by a final solution.

11. The computer readable medium as set forth in claim 7 further comprising software for performing the steps of building an overlay network in response to having unroutable demands on said existing network;
routing said unroutable demands on said overlay network; and
outputting a description of said overlay network.

12. The computer readable medium as set forth in claim 7 further comprising software for re-routing any existing demands onto said existing network structure.

13. A system for placing unrouted new demands on an existing network structure, said system comprising:
a network translator for translating the existing network to a capacity network such that it is conducive to application of mathematical and heuristics techniques, said capacity network being organized as a connected flat topology;
a solver for solving subsets of the unrouted new demands using min-cost flow processes in order to route as many of the new demands onto the existing network as can be accommodated by the existing network, said solver receiving said translated existing network; and
a results outputter for outputting a list of routed demands and unrouted demands.

14. The system as set forth in claim 13 wherein said network translator is adapted to model system equipment interactions or transitions with transition nodes that mark the behavior of equipment within the existing network, such that said translated network is a representation of the existing network in an operations research network flows domain.

15. The system as set forth in claim 13 wherein said solver is adapted to use only spare capacity of the existing network for routing of new demands, such that routing of all pre-existing routed demands is maintained.

16. The system as set forth in claim 13 wherein said solver is adapted to use all capacity of the existing network for routing of new demands such that pre-existing routed demands are not accommodated by a final solution.

17. The system as set forth in claim 13 further comprising:
an overlay network builder for building an overlay network in response to having unroutable demands on said existing network;
an overlay network router for routing said unroutable demands on said overlay network; and
an overlay network description outputter for outputting a description of said overlay network.

18. The system as set forth in claim 13 wherein said solver is further adapted to re-route any existing demands onto the existing network.
